(19) United States
(12) Patent Application Publication
(10) Pub. No.: US 2026/0080273 A1
(43) Pub. Date: Mar. 19, 2026

(54) INFORMATION PROCESSING APPARATUS, INFORMATION PROCESSING METHOD, AND COMPUTER PROGRAM PRODUCT

(71) Applicants: KABUSHIKI KAISHA TOSHIBA, Tokyo (JP); National University Corporation Shiga University, Shiga (JP)

(72) Inventors: Ryusei SHINGAKI, Tokyo (JP); Kaneharu NISHINO, Kawasaki (JP); Thong The PHAM, Osaka (JP)

(73) Assignees: KABUSHIKI KAISHA TOSHIBA, Tokyo (JP); National University Corporation Shiga University, Shiga (JP)

(21) Appl. No.: 19/270,693

(22) Filed: Jul. 16, 2025

(30) Foreign Application Priority Data
Sep. 17, 2024 (JP) 2024-159840

(51) Int. Cl. G06N 5/022

(52) U.S. Cl. CPC G06N 5/022

(57) ABSTRACT

An information processing apparatus includes processors. The processors construct a predictive model serving to receive respective pieces of first time-series data of input variables in a first period of time and predicts output variables to be obtained at a time point after the first period of time. The processors calculate third time-series data being time-series data of an index representing an error or a goodness of fit between (i) pieces of second time-series data representing the output variables predicted by the predictive model at time points included in the first period of time and (ii) correct time-series data representing correct answers to the output variables at the time points in the first period of time. The processors construct a time-series causal graph representing causality between the input variables and the index by using the pieces of first time-series data and the third time-series data.

### CROSS-REFERENCE TO RELATED APPLICATIONS

This application is based upon and claims the benefit of priority from Japanese Patent Application No. 2024-159840, filed on Sep. 17, 2024; the entire contents of which are incorporated herein by reference.

### FIELD

Embodiments described herein relate generally to an information processing apparatus, an information processing method, and a computer program product.

### BACKGROUND

Prediction methods using predictive models, which is obtained through machine learning, have shown remarkable performance in a wide range of predictive tasks.

On the other hand, the black-box nature of predictive models may be problematic when such predictive methods are adopted for socially influential infrastructure services or the like.

For attempting to provide an interpretation of predictive models having the black-box nature, methods such as Shapley additive explanations (SHAP) and local interpretable model-agnostic explanations (LIME) that attempt to provide a posteriori explanations of predictive models have been known. These are methods intended to explain a cause of a predicted value in response to giving input data.

In actuality, an interest is often focused on, rather than interpretation by a predictive model, why a predicted value deviates from an actual value or an actually measured value that correspond to a value representing a correct answer.

### BRIEF DESCRIPTION OF THE DRAWINGS

FIG. 1 is a block diagram of an information processing apparatus according to an embodiment;

FIG. 2 is a flowchart of an analysis process according to the embodiment;

FIG. 3 is a diagram illustrating an example of combined time-series data;

FIG. 4 is a diagram illustrating an example of a time-series causal graph;

FIG. 5 is a diagram illustrating an example of training data; and

FIG. 6 is a hardware configuration diagram of the information processing apparatus according to the embodiment.

### DETAILED DESCRIPTION

An information processing apparatus according to one embodiment includes one or more hardware processors. The hardware processors are configured to construct a predictive model serving to receive respective pieces of first time-series data of plural input variables in a first period of time and predict one or more output variables to be obtained at a time point after the first period of time. The hardware processors are configured to calculate third time-series data being time-series data of an index representing an error or a goodness of fit between (I) one or more pieces of second time-series data representing the one or more output variables predicted by the predictive model at one or more time points included in the first period of time and (ii) correct time-series data representing correct answers to the one or more output variables at the one or more time points in the first period of time. The hardware processors are configured to construct a time-series causal graph representing causality between the plural input variables and the index by using the pieces of first time-series data and the third time-series data.

Preferred embodiments of an information processing apparatus according to the invention will be described in detail below with reference to the accompanying drawings.

In the following embodiment, a predictive model EM (predictive model) is used for predicting one or more output variables (objective variables) at a specified time point (for example, time point in the future) on the basis of pieces of time-series data TDA (first time-series data) that are time-series data of input variables (explanatory variables). In the following, an example of a predictive model EM that predicts one output variable will be mainly described, whereas the same procedure can also be applied to a predictive model EM that predicts output variables. Note that the prediction is not limited to estimating information (such as output variables) at a time point in the future and includes estimating information at any time point.

The input variables may include variables that are of the same type as variables to be predicted (output variable) and are acquired prior to the specified time point. Thus, the predictive model EM may be a model serving to predict a value of a specific variable to be obtained at a future time point in response to receiving the variables including a past value of the specific variable.

The time-series data TDA is, for example, data collected from various devices used in a target system. The target system may be any system, and is, for example, the following system.
A system that uses observed values such as rainfall at plural locations as input variables and predicts the inflow of rainwater or the like at a specified location (dam, river, or the like) as an output variable.
A system that uses observed values such as wind speed and relative humidity at plural points as input variables and predicts the visibility affected by fog, snowstorm, or the like at a specified location (airport, road, or the like) as an output variable.
A system that uses time-series data (sensor values, control values, or the like) collected from a system to be monitored, such as a plant, as input variables and predicts (detects) output variables indicating abnormalities in the system to be monitored.

As noted above, in predictions using the predictive model EM obtained by machine learning, an interest is often focused on why a predicted value deviates from an actual value. It may be required to determining variables that affect a deviation between the actual value and the predicted value. Note that the deviation can be represented by, for example, an error (predictive error) that is a difference between the actual value and the predicted value. An index representing a deviation is not limited to an error, and may be any other indices. For example, the goodness of fit may be used for indicating the degree of fit between the actual value and the predicted value. An example of using an error as an index representing a deviation will be mainly described below.

As one example, suppose that a situation of deviation between an actual value and a predicted value occurs in a system that predicts an inflow at a dam. This situation may occur when a predicted value indicating a low inflow is obtained although prediction results from the predictive model EM have a good predictive error on average and an actual inflow becomes high due to a lot of rainfall. If the reason for the occurrence of such a deviation is not explainable, the predictive model EM is difficult to be adopted.

Meanwhile, a technique has been proposed to determine the extent to which each input variable is involved in determination that a deviation between an actual value and a predicted value for given test data is abnormal. However, such a technique calculates the “degree of responsibility” of statistically related variables and considers no causality among variables.

Considering the above, the following embodiment determines variables that affect a deviation between an actual value and a predicted value for given test data in consideration of the causality between variables in a prediction using the predictive model EM.

The embodiment may include at least some of the following features.
Predicting the value of an output variable at a specified time point in the future on the basis of pieces of time-series data in the past.
Storing, as a predictive error, a difference between a predicted value and an actual value of an output variable at a past point in time.
Searching for a time-series causal graph representing the causality between predictive errors in the past and pieces of time-series data in the past.
Constructing a generative model GM corresponding to a time-series causal graph.
Calculating a degree of contribution of each piece of time-series data (variable) to the predictive error at a specified time point by using the generative model GM.

In the embodiment, a structural causal model (time-series causal graph) between variables is constructed, wherein the variables include the predictive error as one variable as well as variables used for prediction. This makes it possible to graphically depict the causality between the predictive error and the root cause of the predictive error, and to facilitate the interpretation of the predictive model.

In the embodiment, the generative model GM is constructed as a model serving to generate predicted values of time-series data corresponding to nodes of the time-series causal graph. With the generative model GM, it is possible to calculate the degree of contribution of variables serving as candidates for root causes of predictive errors.

There is a case where not only actual values (such as observed values) of a variable IDA (first variable) but also predicted values (such as predicted values of weather) of the variable IDA is obtained as input variables. In such a case, a difference between the actual value and the predicted value of the variable IDA may also be set as a new variable and a time-series causal graph between variables may be constructed. This makes it possible to analyze the relationship between the predictive error by the predictive model EM and the difference for the variable IDA.

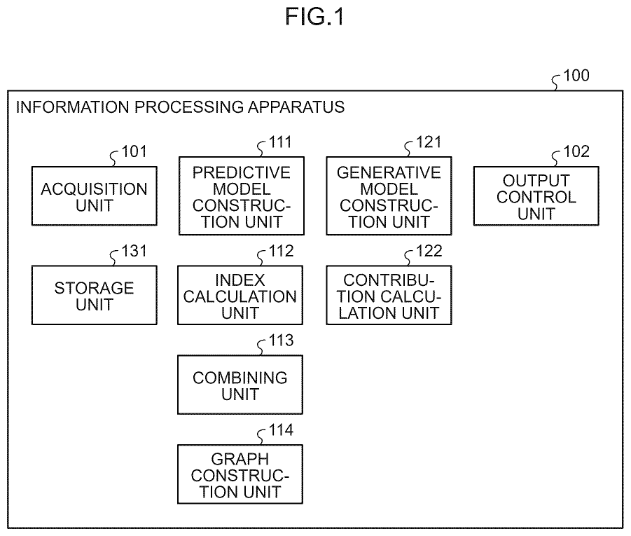

FIG. 1 is a block diagram illustrating an example of the configuration of an information processing apparatus 100 of the embodiment. As illustrated in FIG. 1, the information processing apparatus 100 includes a storage unit 131, an acquisition unit 101, a predictive model construction unit 111, an index calculation unit 112, a combining unit 113, a graph construction unit 114, a generative model construction unit 121, a contribution calculation unit 122, and an output control unit 102.

The storage unit 131 stores various information used by the information processing apparatus 100. The various information may include time-series data acquired by the acquisition unit 101, results of processing by each unit, and the like.

Note that the storage unit 131 can be constituted by any commonly used storage medium such as a flash memory, a memory card, a random-access memory (RAM), a hard disk drive (HDD), and an optical disk.

The acquisition unit 101 acquires various information used by the information processing apparatus 100. In one example, the acquisition unit 101 acquires pieces of time-series data TDA used for a prediction by the predictive model EM. The pieces of time-series data TDA are, for example, data collected in advance and stored in a database or the like outside the information processing apparatus 100.

A physical relationship may exist between the pieces of time-series data TDA. For example, in the case of the pieces of time-series data TDA obtained by measuring the flow rate or rainfall at a dam or river, the sum of the flow rate or rainfall at an upstream dam or river is considered to correspond to the flow rate of a downstream dam or river. This is because water from the upstream dam or river and rain that falls on a river basin flow into the downstream dam or river. Accordingly, for example, a physical relationship exists between time-series data of input variables representing the flow rate of the upstream dam and time-series data of input variables representing the flow rate of the downstream dam or river.

As described above, the pieces of time-series data TDA may include not only time-series data of actual values of a variable IDA, but also time-series data of predicted values of the variable IDA (such as predicted values of weather). For example, the pieces of time-series data TDA may include time-series data representing actual rainfall at a location and time-series data representing a predicted value of rainfall at the location.

Any method may be used for acquiring information by the acquisition unit 101, and, for example, a method for receiving the information from an external device via a network, a method for reading the information from a storage medium, or the like can be applied.

The predictive model construction unit 111 constructs the predictive model EM. The predictive model construction unit 111 constructs the predictive model EM serving to receive pieces of time-series data TDA in a period TA (an example of a first period of time) and predict an output variable at a time point after the period TA.

The index calculation unit 112 calculates time-series data of a predictive error (an example of an index) that is a difference between a predicted value by the predictive model EM and an actual value. For example, the index calculation unit 112 calculates time-series data TDC (third time-series data) of an error between one or more time-series data TDB (second time-series data) and correct time-series data.

The one or more time-series data TDB correspond to one or more time-series data representing output variables predicted by the predictive model EM with respect to each of one or more time points included in the period TA. The correct time-series data are time-series data representing correct answers of the output variables at the one or more time points included in the period TA. The correct time-series data are, for example, time-series data corresponding to actual values of variables corresponding to the output variables obtained at each time point in the period TA.

The combining unit 113 generates combined time-series data by combining the pieces of time-series data TDA and the time-series data TDC.

The graph construction unit 114 constructs a time-series causal graph by using the pieces of time-series data TDA and the time-series data TDC. In one example, the graph construction unit 114 constructs the time-series causal graph by using the combined time-series data. The time-series causal graph corresponds to a graph representing the causality between input variables (the pieces of time-series data TDA) and the predictive error (the time-series data TDC).

When the time-series data for the predicted values of the variable IDA are obtained, the graph construction unit 114 may construct the time-series causal graph by further using time-series data TDD (fourth time-series data) of the difference between the actual values of the variable IDA and the predicted values of the variable IDA. Specifically, the combining unit 113 generates combined time-series data by combining the pieces of time-series data TDA, the time-series data TDC, and the time-series data TDD. The graph construction unit 114 constructs the time-series causal graph by using the combined time-series data including the time-series data TDD.

The generative model construction unit 121 constructs a generative model GM by using the time-series causal graph. The generative model corresponds to, for example, a model serving to generate input variables corresponding to nodes NB (second nodes), which are child nodes of nodes NA (first nodes), from input variables corresponding to the nodes NA included in the time-series causal graph.

The contribution calculation unit 122 calculates the degree of contribution of the input variables to the predictive error by using the generative model.

The output control unit 102 controls the output of various information used by the information processing apparatus 100. In one example, the output control unit 102 outputs the constructed time-series causal graph and the calculated degree of contribution. Any method may be used for outputting information, and, for example, a method for displaying the information on a display device, a method for transmitting the information to an external device via a network, or the like can be used.

At least some of the above units (the acquisition unit 101, the predictive model construction unit 111, the index calculation unit 112, the combining unit 113, the graph construction unit 114, the generative model construction unit 121, the contribution calculation unit 122, and the output control unit 102) may be implemented by one or more processing units. Each of the above units is implemented by, for example, one or more hardware processors. Each of the above units may be implemented by causing a hardware processor, such as a central processing unit (CPU) and a graphics processing unit (GPU), to execute a computer program, namely, implemented by software. Each of the above units may be implemented by a processor such as a dedicated integrated circuit (IC), namely, implemented by hardware. Each of the above units may be implemented with a combination of software and hardware. When plural processors are used, each processor may implement one of the units or two or more of the units.

The information processing apparatus 100 may also be physically constituted by one device or may also be physically constituted by a plurality of devices. The information processing apparatus 100 may also be constructed on a cloud environment. The units in the information processing apparatus 100 may also be distributed among plural devices.

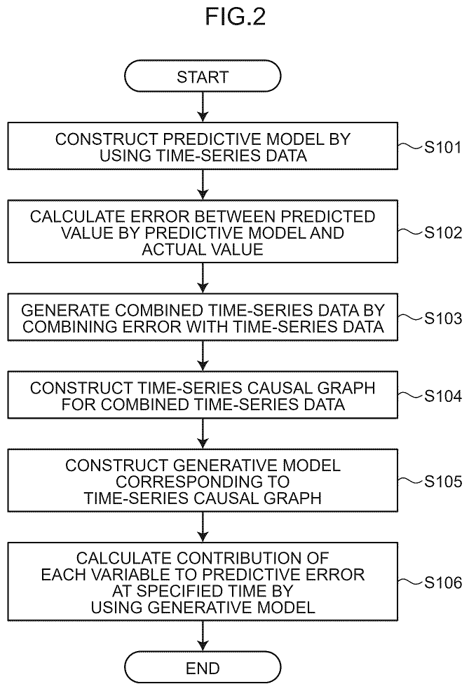

An analysis process performed by the information processing apparatus 100 of the embodiment will be described below. FIG. 2 is a flowchart illustrating an example of the analysis process in the embodiment. The analysis process includes a process of constructing a time-series causal graph, a process of calculating the degree of contribution of variables to a predictive error, and the like.

First, the predictive model construction unit 111 constructs a predictive model EM by using pieces of time-series data acquired by the acquisition unit 101 (step S101). The predictive model EM is a model serving to receive time-series data of a specified input variable among the pieces of acquired time-series data, and predict and output a value of a specified output variable. The predictive model construction unit 111, for example, constructs the predictive model EM by using, as training data, pieces of time-series data TDA obtained at plural time points in the past. In the following, a period during which the training data is obtained may be referred to as a training period.

When predicting, for example, inflow at a specific dam, pieces of time-series data, such as time-series data of dam inflows for the past several years and time-series data of rainfall for the past several years (or time-series data of predicted rainfall in the past), are used as training data. The predictive model construction unit 111 performs learning (or construction) of the predictive model EM for predicting a dam inflow at a specified time point in the future from the relationship between a dam inflow included in the training data and pieces of time-series data such as rainfall or predicted rainfall.

The learning of the predictive model EM will be further described. Times 1, . . . , T₁ are set as a training period. Times T₁+1, . . . , T₁+T₂ are set as a test period. The test period corresponds to a period during which time-series data used in the process of calculating the degree of contribution of each variable to the predictive error is obtained. For convenience of description, the test period is assumed to start immediately after the training period (T₁+1). The test period may start at any time point after the training period. The same procedure as described below can be applied even when the test period starts at time T₁+h (h is a positive value).

Pieces (for example, p pieces) of time-series data in the training period are defined by Equation (1) below. The time-series data of variables corresponding to prediction targets (output variables) in the training period are defined by Equation (2) below.

$$\{ {X}_{1 , 1} , {X}_{1 , 2} , … , {X}_{1 , {T}_{1}} \} , \{ {X}_{2 , 1} , {X}_{2 , 2} , … , {X}_{2 , {T}_{1}} \} , … , \{ {X}_{p , 1} , {X}_{p , 2} , … , {X}_{p , {T}_{1}} \} \qquad ( 1 )$$

$$\{ {Y}_{1} , {Y}_{2} , … , {Y}_{{T}_{1}} \} \qquad ( 2 )$$

Therefore, training data D₁ is defined by Equation (3) below. The training data D₁ corresponds to the pieces of time-series data TDA.

$${𝒟}_{1} = \{ \begin{matrix}( {X}_{1 , 1} , {X}_{2 , 1} , … , {X}_{p , 1} , {Y}_{1} ) , \\ ( {X}_{1 , 2} , {X}_{2 , 2} , … , {X}_{p , 2} , {Y}_{2} ) , … , \\ ( {X}_{1 , {T}_{1}} , {X}_{2 , {T}_{1}} , … , {X}_{p , {T}_{1}} , {Y}_{{T}_{1}} )\end{matrix} \} \qquad ( 3 )$$

Pieces (for example, p pieces) of time-series data in the test period are defined by Equation (4) below. The time-series data of variables corresponding to prediction targets (output variables) in the test period are defined by Equation (5) below.

$$\{ {X}_{1 , {T}_{1} + 1} , {X}_{1 , {T}_{1} + 2} , … , {X}_{1 , {T}_{1} + {T}_{2}} \} , \{ {X}_{2 , {T}_{1} + 1} , {X}_{2 , {T}_{1} + 2} , … , {X}_{2 , {T}_{1} + {T}_{2}} \} , … , \{ {X}_{p , {T}_{1} + 1} , {X}_{p , {T}_{1} + 2} , … , {X}_{p , {T}_{1} + {T}_{2}} \} \qquad ( 4 )$$

$$\{ {Y}_{{T}_{1} + 1} , {Y}_{{T}_{1} + 2} , … , {Y}_{{T}_{1} + {T}_{2}} \} \qquad ( 5 )$$

Therefore, test data D₂ is defined by Equation (6) below.

$${𝒟}_{2} = \{ \begin{matrix}( {X}_{1 , {T}_{1} + 1} , {X}_{2 , {T}_{1} + 1} , … , {X}_{p , {T}_{1} + 1} , {Y}_{{T}_{1} + 1} ) , \\ ( {X}_{1 , {T}_{1} + 2} , {X}_{2 , {T}_{1} + 2} , … , {X}_{p , {T}_{1} + 2} , {Y}_{{T}_{1} + 2} ) , … , \\ ( {X}_{p , {T}_{1} + 1} , {X}_{p , {T}_{1} + 2} , … , {X}_{p , {T}_{1} + {T}_{2}} , {Y}_{{T}_{1} + {T}_{2}} )\end{matrix} \} \qquad ( 6 )$$

Each time point included in the training period and the test period is at regular time intervals. The regular time intervals may be any value, such as every other day, every hour, or the like. A length T₁ of the training period and a length T₂ of the test period may be any value. In one example, T₁ is five years and T₂ is one year.

The predictive model construction unit 111 is configured to modelizer, by using the training data D₁, the relationship between time-series data X_{1,(t-w+1):t}, X_{2, (t-w+1):t}, . . . , X_{u,(t-w+1):t}, Y_{(t-w+1):t} for input variables of length w up to time t∈{1, . . . , T₁} and an output variable Yₜ₊₁ at time t+1 as in Equation (7) below.

$${Y}_{t + 1} = f ( {X}_{1 , ( t - w + 1 ) : t} , {X}_{2 , ( t - w + 1 ) : t} , ... , {X}_{p , ( t - w + 1 ) : t} , {Y}_{( t - w + 1 ) : t} ) + ε \qquad ( 7 )$$

X_{i,(t-w+1):t} is (X_{i,t-w+1}, X_{i,t-w+2}, . . . , X_{i,t-1}, X_{i,t}). Y (t−w+1):t is (Y_{t-w+1}, Y_{t-w+2}, . . . , Yₜ₋₁, Yₜ). ε denotes an error term.

In the example of Equation (7) above, the function f(·) corresponds to the predictive model EM. The function f(·) may be any model as long as serving to receive time-series data for input variables and output predicted values for one or more output variables. The function f(·) may be a simple model such as a linear regression model, or may be a neural network model such as a long short term memory (LSTM).

The method for learning the function f(·) by using the training data D₁ may be any method applicable to the function f(·) to be adopted. For example, the predictive model construction unit 111 may use (T₁−w) pieces of (p+1) variate time-series data of length w included in the training data D₁ and defined by Equation (8) below, and calculate parameters of a function f of minimizing a loss function such as squared loss defined by Equation (9) below, with an optimization method such as a stochastic gradient method.

$$\{ {X}_{1 , 1 : w} , {X}_{2 , 1 : w} , ... , {X}_{p , 1 : w} , {Y}_{1 : w} , {Y}_{w + 1} \} , \qquad ( 8 )$$

$$\{ {X}_{1 , 2 : ( w + 1 )} , {X}_{2 , 2 : ( w + 1 )} , ... , {X}_{p , 2 : ( w + 1 )} , {Y}_{2 : ( w + 1 )} , {Y}_{w + 2} \} , ... ,$$

$$\{ {X}_{1 , ( {T}_{1} - 1 - w ) : ( {T}_{1} - 2 )} , {X}_{2 , ( {T}_{1} - 1 - w ) : ( {T}_{1} - 2 )} , ... , \\ {X}_{p , ( {T}_{1} - 1 - w ) : ( {T}_{1} - 2 )} , {Y}_{( {T}_{1} - 1 - w ) : ( {T}_{1} - 2 )} , {Y}_{{T}_{1} - 1} \} ,$$

$$\{ {X}_{1 , ( {T}_{1} - w ) : ( {T}_{1} - 1 )} , {X}_{2 , ( {T}_{1} - w ) : ( {T}_{1} - 1 )} , ... , {X}_{p , ( {T}_{1} - w ) : ( {T}_{1} - 1 )} , {Y}_{( {T}_{1} - w ) : ( {T}_{1} - 1 )} , {Y}_{{T}_{1}} \}$$

$$\frac{1}{{T}_{1} - w} {\sum }_{t = w}^{{T}_{1} - 1} {( {Y}_{t + 1} - f ( {X}_{1 , ( t - w + 1 ) : t} , {X}_{2 , ( t - w + 1 ) : t} , ... , {X}_{p , ( t - w + 1 ) : t} , {Y}_{( t - w + 1 ) : t} ) )}^{2} \qquad ( 9 )$$

The predicted value of the function f based on the parameters learned in this way is denoted by f\hat{ } (f hat: a symbol with a hat symbol above the symbol f).

The loss function to be minimized is not limited to squared loss, and may be any other function defining loss. In one example, the loss function may be L1 loss as in Equation (10) below.

$$\frac{1}{{T}_{1} - w} {\sum }_{t = w}^{{T}_{1} - 1} \vert {Y}_{t + 1} - f ( {X}_{1 , ( t - w + 1 ) : t} , {X}_{2 , ( t - w + 1 ) : t} , ... , {X}_{p , ( t - w + 1 ) : t} , {Y}_{( t - w + 1 ) : t} ) \vert \qquad ( 10 )$$

Instead of obtaining the parameters that minimize the loss function, the predictive model construction unit 111 may obtain parameters of the function f of maximizing an index corresponding to the goodness of fit by using an optimization method such as a stochastic gradient method. The index corresponding to the goodness of fit is, for example, a log-likelihood that is obtained by assuming that an error Et defined by Equation (11) below follows a specific probability distribution. The specific probability distribution is, for example, a normal distribution with mean u defined by Equation (12) below and variance σ² defined by Equation (13) below. The log likelihood in this case is given by Equation (14) below. The goodness of fit such as the log likelihood can be used as an index representing a deviation instead of the predictive error as described above.

$${ε}_{t} = {Y}_{t + 1} - f ( {X}_{1 , ( t - w + 1 ) : t} , {X}_{2 , ( t - w + 1 ) : t} , ... , {X}_{p , ( t - w + 1 ) : t} , {Y}_{( t - w + 1 ) : t} ) \qquad ( 11 )$$

$$\frac{1}{{T}_{1} - w} {\sum }_{t = w}^{{T}_{1} - 1} ( {Y}_{t + 1} - f ( {X}_{1 , ( t - w + 1 ) : t} , {X}_{2 , ( t - w + 1 ) : t} , ... , {X}_{p , ( t - w + 1 ) : t} , {Y}_{( t - w + 1 ) : t} ) ) \qquad ( 12 )$$

$$\frac{1}{{T}_{1} - w} {\sum }_{t = w}^{{T}_{1} - 1} {( {Y}_{t + 1} - f ( {X}_{1 , ( t - w + 1 ) : t} , {X}_{2 , ( t - w + 1 ) : t} , ... , {X}_{p , ( t - w + 1 ) : t} , {Y}_{( t - w + 1 ) : t} ) )}^{2} \qquad ( 13 )$$

$${\sum }_{t = w}^{{T}_{1} - 1} log \frac{1}{\sqrt{2 π} σ} exp \{ - \frac{1}{2 {σ}^{2}} {( {ε}_{t} - μ )}^{2} \} = ( {T}_{1} - w ) log \frac{1}{\sqrt{2 π} σ} - \frac{1}{2} {\sum }_{t = w}^{{T}_{1} - 1} {( \frac{{ε}_{t} - μ}{σ} )}^{2} \qquad ( 14 )$$

Return to the description in FIG. 2. When the predictive model EM (function f\hat{ }) is constructed as described above, the index calculation unit 112 calculates an error (predictive error) between a predicted value by the predictive model EM and an actual value (step S102). Specifically, the index calculation unit 112 calculates a predictive error Rₜ₊₁ at time t∈{w, . . . , T₁−1} by using the function f\hat{ }, as in Equation (15) below. The index calculation unit 112 obtains the predicted value of an output variable by inputting the time-series data of the length w included in the training data D₁ into the function f\hat{ }. In Equation (15), Yₜ₊₁ corresponds to the actual value of the output variable at time t+1.

$${R}_{t + 1} = {Y}_{t + 1} - \hat{f} ( {X}_{1 , ( t - w + 1 ) : t} , {X}_{2 , ( t - w + 1 ) : t} , ... , {X}_{p , ( t - w + 1 ) : t} , {Y}_{( t - w + 1 ) : t} ) \qquad ( 15 )$$

The predictive error is not limited to a simple difference as defined by Equation (15) above, and an absolute value of the difference, a value obtained by squaring the difference, or the like may be used.

Return to the description in FIG. 2. The combining unit 113 generates combined time-series data by combining the pieces of time-series data TDA and the time-series data TDC corresponding to the time-series data of the predictive error (step S103). Equation (16) below shows an example of each time-series data constituting the combined time-series data. The predictive error R_{(w+1):T_1} represents the predictive error Rₜ₊₁ calculated at step S102 for each time t∈{w, . . . , T₁−1} and corresponds to the time-series data TDC of the error. X_{i,(w+1):T_1} and Y_{(w+1):T_1} correspond to time-series data TDA in the same period (time w to time T₁−1).

$${R}_{( w + 1 ) : {T}_{1}} = ( {R}_{w + 1} , {R}_{w + 2} , ... , {R}_{{T}_{1} - 1} , {R}_{{T}_{1}} ) , \qquad ( 16 )$$

$${X}_{i , ( w + 1 ) : {T}_{1}} = ( {X}_{i , w + 1} , {X}_{i , w + 2} , ... , {X}_{i , {T}_{1} - 1} , {X}_{{T}_{1}} ) ,$$

$${Y}_{( w + 1 ) : {T}_{1}} = ( {Y}_{w + 1} , {Y}_{w + 2} , ... , {Y}_{{T}_{1} - 1} , {Y}_{{T}_{1}} )$$

The combining unit 113 combines the predictive error R (w+1):T_1, X_{i, (w+1):T_1}, and Y_{(w+1):T_1} defined by Equation (16) above to generate combined time-series data defined by Equation (17) below.

$$\{ {X}_{1 , ( w + 1 ) : {T}_{1}} , {X}_{2 , ( w + 1 ) : {T}_{1}} , ... , {X}_{p , ( w + 1 ) : {T}_{1}} , {Y}_{( w + 1 ) : {T}_{1}} , {R}_{( w + 1 ) : {T}_{1}} \} \qquad ( 17 )$$

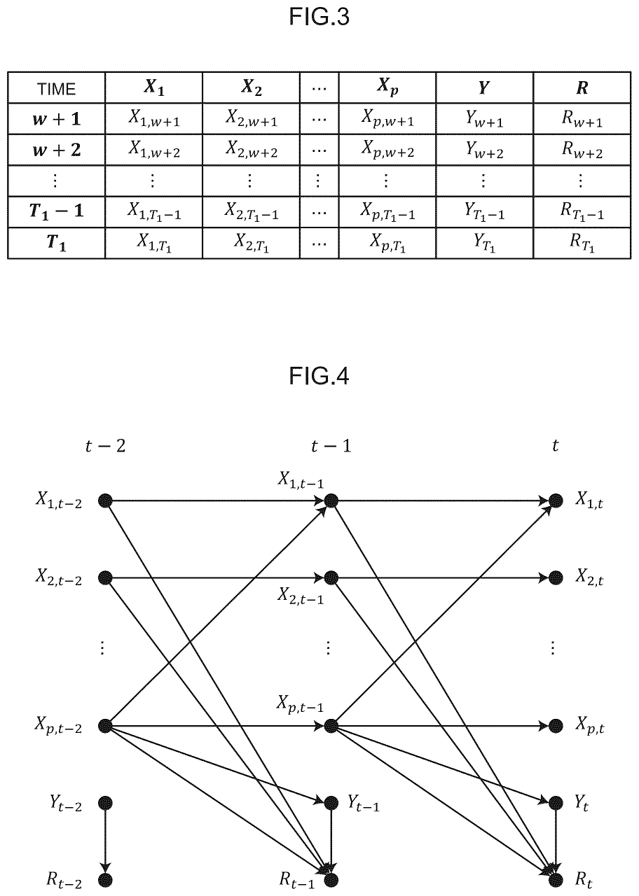

The combined time-series data can be regarded as tabular data as illustrated in FIG. 3. FIG. 3 is a diagram illustrating an example of the combined time-series data represented in a table format.

In FIG. 3, a first column represents time (time points), second to (p+1)th columns represent p pieces of time-series data, a (p+2)th column represents time-series data of variables corresponding to a prediction target (output variable), and a (p+3)th column represents time-series data of the predictive errors calculated by the index calculation unit 112.

Return to the description in FIG. 2. The graph construction unit 114 constructs a time-series causal graph for the generated combined time-series data (step S104). The graph construction unit 114 constructs, by using the generated combined time-series data, a time-series causal graph representing the causality between pieces of the time-series data from the second column to the (p+3)th column. The graph construction unit 114 can construct the time-series causal graph from the time-series data, for example, by using a PCMCI algorithm (see, for example, J. Runge, P. Nowack, M. Kretschmer, S. Flaxman, D. Sejdinovic, “Detecting and quantifying causal associations in large nonlinear time series datasets.”, Sci. Adv. 5, eaau4996, 2019).

FIG. 4 is a diagram illustrating an example of a time-series causal graph to be constructed. FIG. 4 is an example of a time-series causal graph when w is 2. Circle symbols of FIG. 4 represent nodes constituting the graph. In the example of FIG. 4, the time-series causal graph includes nodes corresponding to the following variables.

$${X}_{1 , t - 2} , {X}_{2 , t - 2} , ... , {X}_{p , t - 2} , {Y}_{t - 2} , {R}_{t - 2} ,$$

$${X}_{1 , t - 1} , {X}_{2 , t - 1} , ... , {X}_{p , t - 1} , {Y}_{t - 1} , {R}_{t - 1} ,$$

$${X}_{1 , t} , {X}_{2 , t} , ... , {X}_{p , t} , {Y}_{t} , {R}_{t}$$

Return to the description in FIG. 2. The generative model construction unit 121 constructs (performs learning of) a generative model corresponding to the time-series causal graph constructed by the graph construction unit 114 (step S105). The generative model is a model corresponding to a data generation mechanism of time-series components corresponding to each node of the time-series causal graph.

The generative model construction unit 121 treats the time-series components corresponding to each node as being generated by functions such as in Equation (18) below.

$${X}_{i , t} = {g}_{{X}_{i , t}} ( pa ( {X}_{i , t} ) ) + {N}_{i , t} for i = 1 , ... , p \qquad ( 18 )$$

$${Y}_{t} = {g}_{{Y}_{t}} ( pa ( {Y}_{t} ) ) + {N}_{y , t}$$

$${R}_{t} = {g}_{{R}_{t}} ( pa ( {R}_{t} ) ) = {Y}_{t} - \hat{f} ( pa ( {R}_{t} ) \backslash {Y}_{t} )$$

pa(·) denotes a parent node in the time-series causal graph. Nit denotes noise in the generation of the variable X_{i,t}. N_{y,t} denotes noise in the generation of the variable Yₜ. g_{X_i,t}(·) denotes a function of generating X_{i,t}. g_{Y_t}(·) denotes a function of generating Yₜ. g_{R_t}(·)=Yₜ−f\hat{ }(·) denotes a function of generating Rₜ.

The first line of Equation (18) above corresponds to a generative model for the variable X_{i,t} among the input variables, and the second line corresponds to a generative model for the variable Yₜ among the input variables. The generative model in Equation (18) above corresponds to a model serving to calculate a value, as a value of a variable corresponding to a child node, by adding noise to a value calculated based on a value of a variable corresponding to a parent node. The third line of Equation (18) can be defined by the already obtained predictive model EM (function f\hat{ }). Therefore, g_{R_t}(·) does not need to be predicted.

On the assumption that the functions g_{X_i,t}(·) and g_{Y_t}(·) are linear, the generative model construction unit 121 predicts these g_{X_i,t}(·) and g_{Y_t}(·). The functions to be predicted may be denoted by g_{X_i,t}\hat{ }(·) and g_{Y_t}\hat{ }(·) with a hat symbol “\hat{ }”.

First, the generative model construction unit 121 generates combined time-series data defined by the following Equation (19) with the range of time that has been expanded to T₁+T₂.

$$\{ {X}_{1 , ( w + 1 ) : ( {T}_{1} + {T}_{2} )} , {X}_{2 , ( w + 1 ) : ( {T}_{1} + {T}_{2} )} , ... , \\ {X}_{p , ( w + 1 ) : ( {T}_{1} + {T}_{2} )} , {Y}_{( w + 1 ) : ( {T}_{1} + {T}_{2} )} , {R}_{( w + 1 ) : ( {T}_{1} + {T}_{2} )} \} \qquad ( 19 )$$

The generative model construction unit 121 generates, by using the generated combined time-series data, time-series data X_{1,t} to X_{p,t}, Yₜ, X_{1,t-1} to X_{p,t-1}, . . . , X_{1,t-w} to X_{p,t-w}, . . . , Rₜ corresponding to nodes of the time series causal graph described below. This time-series data can be interpreted as data delayed in time to T₂. Thus, it may be referred to as time-delayed data in the following description.

$${X}_{1 , t} , {X}_{2 , t} , ... , {X}_{p , t} , {Y}_{t} , {R}_{t} ,$$

$${X}_{1 , t - 1} , {X}_{2 , t - 1} , ... , {X}_{p , t - 1} , {Y}_{t - 1} , {R}_{t - 1} , ... ,$$

$${X}_{1 , t - w} , {X}_{2 , t - w} , ... , {X}_{p , t - w} , {Y}_{t - w} , {R}_{t - w}$$

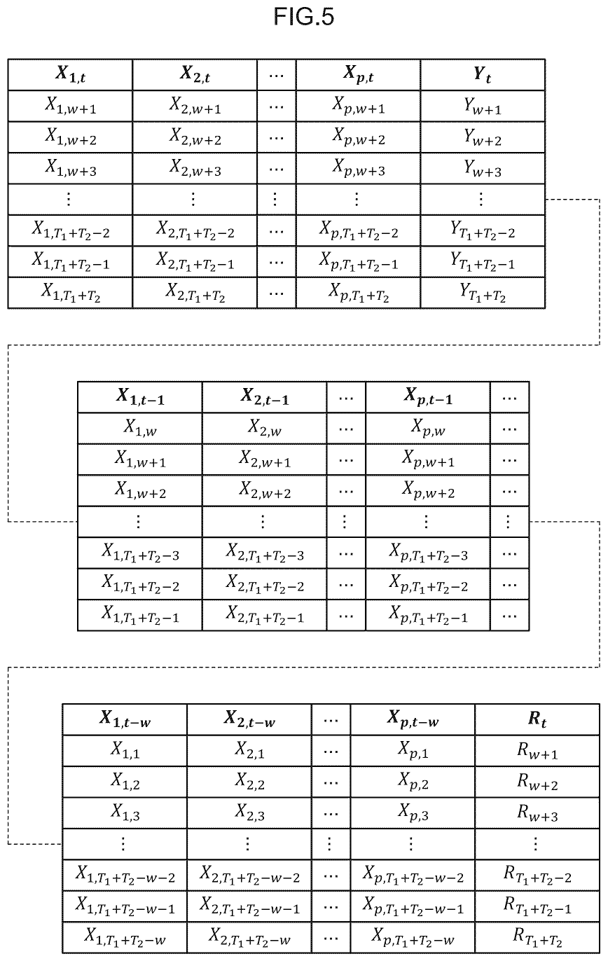

The generative model construction unit 121 performs learning of the linear functions g_{X_i,t}(·) and g_{Y_t}(·) by using, for example, at least some pieces of the time-delayed data as training data. FIG. 5 is a diagram illustrating an example of the training data used in this case. As illustrated in FIG. 5, the training data can be regarded as tabular data. The generative model construction unit 121 performs learning of the function g_{X_i,t}(·) by using the time-series data of a column corresponding to pa(X_{i,t}) in the training data in FIG. 5. The generative model construction unit 121 also performs learning of the function g_{Y_t}(·) by using the time-series data of a column corresponding to pa(Yₜ) of the training data in FIG. 5.

Return to the description in FIG. 2. The contribution calculation unit 122 calculates the degree of contribution of each variable to the predictive error Rₜ₊₁ at a specified time point by using the generative model (step S106). The predictive error Rₜ₊₁ is a predictive error at the specified time point t+1∈{T₁+1 . . . , T₁+T₂} and is defined by Equation (20) below.

$${R}_{t + 1} = {Y}_{t + 1} - \hat{f} ( {X}_{1 , ( t - w + 1 ) : t} , {X}_{2 , ( t - w + 1 ) : t} , ... , {X}_{p , ( t - w + 1 ) : t} , {Y}_{( t - w + 1 ) : t} ) \qquad ( 20 )$$

In the case of the time-series causal graph illustrated in FIG. 4, the degree of contribution of the variables X_{1,t}, X_{2,t}, . . . , X_{p,t}, Yₜ₊₁ corresponding to the nodes included in the time-series causal graph to the predictive error Rₜ₊₁ is obtained. In one example, the contribution calculation unit 122 calculates the degree of contribution by a method (see, for example, Kailash Budhathoki, Lenon Minorics, Patrick Bloebaum, Dominik Janzing, “Causal structure-based root cause analysis of outliers.”, Proceedings of the 39th International Conference on Machine Learning, PMLR 162:2357-2369, 2022) for calculating the degree of contribution based on the Shapley value from the generative model.

Specifically, the Shapley value shown in Equation (22) below can be used as the degree of contribution Φ(j) of each node j included in a node set V shown in Equation (21) below to Rₜ.

$$V = \{ \begin{matrix}{X}_{1 , t} , {X}_{2 , t} , ... , {X}_{p , t} , {Y}_{t} , \\ {X}_{1 , t - 1} , {X}_{2 , t - 1} , ... , {X}_{p , t - 1} , {Y}_{t - 1} , \\ ... , \\ {X}_{1 , t - w} , {X}_{2 , t - w} , ... , {X}_{p , t - w} , {Y}_{t - w}\end{matrix} \} \backslash \{ {R}_{t} \} \qquad ( 21 )$$

$$Φ ( j ) = {\sum }_{I ⊆ V} \frac{1}{( p + 1 ) ( w + 1 ) ( \begin{matrix}( p + 1 ) ( w + 1 ) - 1 \\ \vert I \vert\end{matrix} )} C ( j \vert I ) \qquad ( 22 )$$

C(j|I) is defined by Equation (23) below. S(Rₜ)\hat{ }rd(IU{j}) is defined by Equation (24) below. S(Rt)\hat{ }rd(I) is defined by Equation (25) below.

$$C ( j \vert I ) = {S ( {R}_{t} )}^{rd ( I ⋃ \{ j \} )} - {S ( {R}_{t} )}^{rd ( I )} \qquad ( 23 )$$

$${S ( {R}_{t} )}^{rd ( I ⋃ \{ j \} )} = - log {P}^{rd ( I ⋃ \{ j \} )} ( \vert \cdot \vert \geq \vert {R}_{t + 1} \vert ) \qquad ( 24 )$$

$${S ( {R}_{t} )}^{rd ( I )} = - log {P}^{rd ( I )} ( \vert \cdot \vert \geq \vert {R}_{t + 1} \vert ) \qquad ( 25 )$$

Equation (24) corresponds to a value obtained by a procedure described below.
For i∈IU{j}, by sampling from (T₁+T₂−w) noises calculated as in Equation (26) below by using g_{X_i,t}\hat{ }(·) and g_{Y_t}\hat{ }(·) while allowing overlap, the (T₁+T₂−w) noises are regenerated.

$${N}_{i , t} = {X}_{i , t} - {\hat{g}}_{{X}_{i , t}} ( pa ( {X}_{i , t} ) ) for t = w + 1 , w + 2 , ... , {T}_{1} + {T}_{2} \qquad ( 26 )$$

Generating, by using the regenerated noise, the predictive error Rₜ from g_{X_i,t}\hat{ }(·) and g_{Y_t}\hat{ }(·) a sufficiently large number of times (for example, 10,000 times or the like).
Obtaining the logarithm of the ratio at which the absolute value of the generated predictive error Rₜ exceeds the absolute value |Rₜ₊₁| of the predictive error at the specified time point t+1∈{T₁+1, . . . , T₁+T₂}, and calculating a negative value of the logarithm.

Equation (25) corresponds to a value obtained by applying the same procedure as above to i∈I instead of i∈IU{j}.

Note that, in a situation where the number of nodes is several tens or more, the amount of calculation required for calculating the degree of contribution Φ(j) may increase. In such a case, a Monte Carlo approximation can be used, in which the value of the degree of contribution Φ(j) is calculated by sampling the set I appearing in the expression for the degree of contribution (j) using a Monte Carlo method.

The above analysis process can present the point in time at which a predictive error, which is a deviation between an actual value and a predicted value of an output variable to be predicted, causally depends on the values of input and output variables. This allows for interpretation of the results of a predictive model and gives an indication of input variable errors that can be improved to reduce the predictive error.

In this manner, the information processing apparatus 100 of the embodiment can facilitate determination of variables that affect an index representing an error or the goodness of fit between a predicted value obtained by the predictive model and a value representing a correct answer.

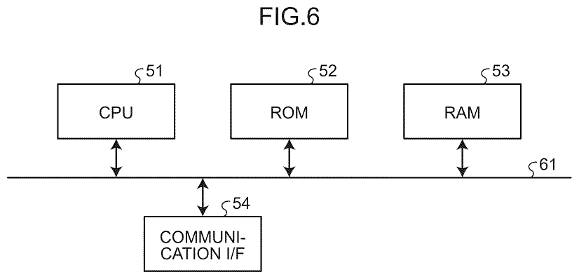

The hardware configuration of the information processing apparatus 100 of the embodiment will be describe below with reference to FIG. 6. FIG. 6 is an explanatory diagram illustrating an example of the hardware configuration of the information processing apparatus 100 of the embodiment.

The information processing apparatus 100 of the embodiment includes a control device such as a central processing unit (CPU) 51, a storage device such as a read only memory (ROM) 52 and a random access memory (RAM) 53, a communication I/F 54 connected to a network to perform communication, and a bus 61 for connecting the units to one another.

A computer program to be executed by the information processing apparatus 100 of the embodiment is preliminarily incorporated in the ROM 52 or the like so as to be provided.

The computer program to be executed by the information processing apparatus 100 of the embodiment may be a file in an installable format or in an executable format, and be recorded in a computer-readable recording medium, such as a compact disc read only memory (CD-ROM), a flexible disk (FD), a compact disc recordable (CD-R), or a digital versatile disc (DVD), so as to be provided as a computer program product.

The computer program to be executed by the information processing apparatus 100 of the embodiment may be stored on a computer connected to a network such as the Internet and be downloaded over the network so as to be provided. The computer program executed by the information processing apparatus 100 of the embodiment may be provided or distributed over the network such as the Internet.

The computer program to be executed by the information processing apparatus 100 of the embodiment enables a computer to function as each unit of the information processing apparatus 100 described above. After the CPU 51 reads the computer program on a main storage device from the computer-readable storage medium, the computer can execute the computer program.

### Supplementary Notes

The above-described embodiment can be summarized in the following technical schemes.

### (Technical Scheme 1)

An information processing apparatus comprising
hardware processors configured to:
   construct a predictive model serving to receive respective pieces of first time-series data of plural input variables in a first period of time and predict one or more output variables to be obtained at a time point after the first period of time;
   calculate third time-series data being time-series data of an index representing an error or a goodness of fit between
      (i) one or more pieces of second time-series data representing the one or more output variables predicted by the predictive model at one or more time points included in the first period of time, and
      (ii) correct time-series data representing correct answers to the one or more output variables at the one or more time points in the first period of time; and
   construct a time-series causal graph representing causality between the plural input variables and the index by using the pieces of first time-series data and the third time-series data.

### (Technical Scheme 2)

The information processing apparatus according to the technical scheme 1, wherein
the plural input variables include an actual value of a first variable and a predicted value of the first variable, and
the hardware processors are configured to construct the time-series causal graph by further using fourth time-series data being time-series data of a difference between the actual value and the predicted value.

### (Technical Scheme 3)

The information processing apparatus according to the technical scheme 1 or 2, wherein the hardware processors are configured to
generate combined time-series data by combining the pieces of first time-series data and the third time-series data, and
construct the time-series causal graph by using the combined time-series data.

### (Technical Scheme 4)

The information processing apparatus according to the technical scheme 3, wherein the hardware processors are configured to
construct a generative model serving to generate the input variables corresponding to second nodes being child nodes of first nodes, from the input variables corresponding to the first nodes included in the time-series causal graph, and
calculate a degree of contribution of the plural input variables to the index by using the generative model.

### (Technical Scheme 5)

The information processing apparatus according to the technical scheme 4, wherein the generative model is a model serving to calculate, as values of the variables corresponding to the second nodes, values obtained by adding noise to values calculated based on the input variables corresponding to the first nodes.

### (Technical Scheme 6)

An information processing method implemented by a computer, the method comprising:
constructing a predictive model serving to receive respective pieces of first time-series data of plural input variables in a first period of time and predicting one or more output variables to be obtained at a time point after the first period of time;
calculating third time-series data being time-series data of an index representing an error or a goodness of fit between
   (i) one or more pieces of second time-series data representing the one or more output variables predicted by the predictive model at one or more time points included in the first period of time, and
   (ii) correct time-series data representing correct answers to the one or more output variables at the one or more time points in the first period of time; and
constructing a time-series causal graph representing causality between the plural input variables and the index by using the pieces of first time-series data and the third time-series data.

### (Technical Scheme 7)

A computer program product comprising a non-transitory computer readable recording medium on which a computer program executable by a computer is recorded, the computer program instructing the computer to perform processing, the processing including:
constructing a predictive model serving to receive respective pieces of first time-series data of plural input variables in a first period of time and predicting one or more output variables to be obtained at a time point after the first period of time;
calculating third time-series data being time-series data of an index representing an error or a goodness of fit between
   (i) one or more pieces of second time-series data representing the one or more output variables predicted by the predictive model at one or more time points included in the first period of time, and
   (ii) correct time-series data representing correct answers to the one or more output variables at the one or more time points in the first period of time; and
constructing a time-series causal graph representing causality between the plural input variables and the index by using the pieces of first time-series data and the third time-series data.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising
hardware processors configured to:
construct a predictive model serving to receive respective pieces of first time-series data of plural input variables in a first period of time and predict one or more output variables to be obtained at a time point after the first period of time;
calculate third time-series data being time-series data of an index representing an error or a goodness of fit between
(i) one or more pieces of second time-series data representing the one or more output variables predicted by the predictive model at one or more time points included in the first period of time, and
(ii) correct time-series data representing correct answers to the one or more output variables at the one or more time points in the first period of time; and
construct a time-series causal graph representing causality between the plural input variables and the index by using the pieces of first time-series data and the third time-series data.

2. The information processing apparatus according to claim 1, wherein
the plural input variables include an actual value of a first variable and a predicted value of the first variable, and
the hardware processors are configured to construct the time-series causal graph by further using fourth time-series data being time-series data of a difference between the actual value and the predicted value.

3. The information processing apparatus according to claim 1, wherein the hardware processors are configured to
generate combined time-series data by combining the pieces of first time-series data and the third time-series data, and
construct the time-series causal graph by using the combined time-series data.

4. The information processing apparatus according to claim 3, wherein the hardware processors are configured to
construct a generative model serving to generate the input variables corresponding to second nodes being child nodes of first nodes, from the input variables corresponding to the first nodes included in the time-series causal graph, and
calculate a degree of contribution of the plural input variables to the index by using the generative model.

5. The information processing apparatus according to claim 4, wherein the generative model is a model serving to calculate, as values of the variables corresponding to the second nodes, values obtained by adding noise to values calculated based on the input variables corresponding to the first nodes.

6. An information processing method implemented by a computer, the method comprising:
constructing a predictive model serving to receive respective pieces of first time-series data of plural input variables in a first period of time and predicting one or more output variables to be obtained at a time point after the first period of time;
calculating third time-series data being time-series data of an index representing an error or a goodness of fit between
(i) one or more pieces of second time-series data representing the one or more output variables predicted by the predictive model at one or more time points included in the first period of time, and
(ii) correct time-series data representing correct answers to the one or more output variables at the one or more time points in the first period of time; and
constructing a time-series causal graph representing causality between the plural input variables and the index by using the pieces of first time-series data and the third time-series data.

7. A computer program product comprising a non-transitory computer readable recording medium on which a computer program executable by a computer is recorded, the computer program instructing the computer to perform processing, the processing including:
constructing a predictive model serving to receive respective pieces of first time-series data of plural input variables in a first period of time and predicting one or more output variables to be obtained at a time point after the first period of time;
calculating third time-series data being time-series data of an index representing an error or a goodness of fit between
(i) one or more pieces of second time-series data representing the one or more output variables predicted by the predictive model at one or more time points included in the first period of time, and
(ii) correct time-series data representing correct answers to the one or more output variables at the one or more time points in the first period of time; and
constructing a time-series causal graph representing causality between the plural input variables and the index by using the pieces of first time-series data and the third time-series data.
